(19) United States
(12) Patent Application Publication
(10) Pub. No.: US 2026/0261052 A1
(43) Pub. Date: Sep. 3, 2026

(54) BASE STATION ANTENNA

(71) Applicant: Outdoor Wireless Networks LLC, Richardson, TX (US)

(72) Inventors: Cheng Xue, Suzhou (CN); Changfu Chen, Suzhou (CN); Pengfei Guo, Suzhou (CN); Bin Sun, Suzhou (CN); Jian Zhang, Suzhou (CN); YueMin Li, Suzhou (CN)

(21) Appl. No.: 19/165,329

(22) PCT Filed: Mar. 26, 2024
(86) PCT No.: PCT/US2024/021428

§ 371 Date: Sep. 15, 2025

(30) Foreign Application Priority Data
Mar. 27, 2023 (CN) 202310311905.X

(51) Int. Cl. H01Q 19/10; H01Q 1/24; H01Q 5/30

(52) U.S. Cl. CPC H01Q 19/10; H01Q 1/246; H01Q 5/30

(57) ABSTRACT

A base station antenna, that may include: a reflector; an array of first radiating elements mounted forwardly of the reflector and configured to emit first electromagnetic radiation within a first frequency band; and a compensation structure mounted forwardly of at least a portion of the first radiating elements of the array of first radiating elements and configured to reflect at least some received first electromagnetic radiation backwards, wherein the compensation structure comprises a first compensation plate and a second compensation plate spaced apart from the first compensation plate, the first compensation plate being positioned to form a first Fabry-Pérot resonance cavity with the reflector for the first electromagnetic radiation, and the second compensation plate being positioned to form a second Fabry-Pérot resonance cavity with the reflector for the first electromagnetic radiation.

### CROSS-REFERENCE TO RELATED APPLICATION

The present application claims the benefit of priority to Chinese Patent Application No. 202310311905.X, filed on Mar. 27, 2023, and the entire contents of the above-identified application are incorporated by reference as if set forth herein.

### TECHNICAL FIELD

The present disclosure generally relates to radio communications and, more particularly, to a base station antenna for use in cellular and other communication systems.

### BACKGROUND

Cellular communications systems are well known in the art. In a cellular communications system, a geographic area is divided into a series of sections that are referred to as “cells” which are served by respective base stations. The base station may include one or more base station antennas that are configured to provide two-way radio frequency (“RF”) communications with mobile subscribers that are within the cell served by the base station.

In many cases, each base station is divided into “sectors”. In perhaps the most common configuration, a small hexagonally shaped cell is divided into three 120° sectors, and each sector is served by one or more base station antennas that produce a radiation pattern or an “antenna beam” with an azimuth half power beam width (HPBW) of approximately 65°. Typically, the base station antennas are mounted on a tower structure, with the antenna beams that are generated by the base station antennas directed outwardly. Base station antennas are often realized as linear or planar phased arrays of radiating elements.

In order to accommodate the ever-increasing volumes of cellular communications, cellular operators have added cellular services in a variety of new frequency bands. In some cases it is possible to use linear arrays of so-called “wideband” or “ultra-wideband” radiating elements to provide service in a plurality of frequency bands, but in other cases it is necessary to use different linear arrays or planar arrays of radiating elements to support service in the different frequency bands.

As the number of frequency bands proliferate, increased sectorization has become more common (e.g., dividing a cell into six, nine or even twelve sectors), and the number of base station antennas deployed at a typical base station has increased significantly. However, due to local zoning ordinances and/or weight and wind loading constraints for the antenna towers, etc. there is often a limit as to the number of base station antennas that can be deployed at a given base station. In order to increase capacity without further increasing the number of base station antennas, so-called multiband antennas have been introduced in which a plurality of arrays of radiating elements are included in a single antenna.

Currently, a multiband antenna is in development which may include one or more linear arrays of “low-band” radiating elements that are used to provide service in some or all of the 617-960 MHz frequency band, and one or more linear arrays of “mid-band” radiating elements that are used to provide service in some or all of the 1427-2690 MHz frequency band. These linear arrays of low-band and mid-band radiating elements are typically mounted in a side-by-side fashion.

Additionally or alternatively, the multiband antenna may further include one or more linear arrays of “high-band” radiating elements that are used to provide service in some or all of the 3.1-5.8 GHz frequency band.

In order to achieve such multiband antennas in a commercially acceptable manner, some parameters of the radiation patterns (e.g. the beam width (such as the azimuth beam width), directivity, roll-off characteristic, and/or gain) of the linear arrays of low-band and mid-band radiating elements within their respective operating frequency bands should meet predetermined design requirements. Unfortunately, different arrays of radiating elements can affect each other, resulting in inter-band or intra-band coupling interference (for example), which can make it challenging to implement such multiband antenna.

In addition, a solution based on an L-type antenna array is known that includes a vertically extending column of radiating elements plus additional radiating elements horizontally offset from a main column of radiating elements. The additional radiating elements are used to reduce the azimuth beam width of the array. Unfortunately, however, the solution based on the L-type antenna array may increase the antenna size, manufacturing costs, antenna weight, and/or commissioning difficulty.

Further, a dielectric lens-based solution is known that typically completely covers the front of the antenna array in order to aggregate antenna beams generated by the antenna array. However, the dielectric lens may increase the antenna size (occupying a larger space), manufacturing costs, antenna weight, and/or commissioning difficulty.

### SUMMARY

Therefore, the objective of the present disclosure is to provide a base station antenna capable of overcoming at least one drawback in the prior art.

According to a first aspect of the present disclosure, a base station antenna is provided, comprising: a reflector; an array of first radiating elements mounted forwardly of the reflector and configured to emit first electromagnetic radiation within a first frequency band; and a compensation structure mounted forwardly of at least a portion of the first radiating elements of the array of first radiating elements and configured to reflect at least some received first electromagnetic radiation backwards, wherein the compensation structure comprises a first compensation plate and a second compensation plate spaced apart from the first compensation plate, the first compensation plate being positioned to form a first Fabry-Pérot resonance cavity with the reflector for the first electromagnetic radiation, and the second compensation plate being positioned to form a second Fabry-Perot resonance cavity with the reflector for the first electromagnetic radiation.

According to a second aspect of the present disclosure, a multiband antenna is provided, comprising: a reflector; a first radiating element mounted to the reflector and configured to emit first electromagnetic radiation within a first frequency band; a second radiating element mounted to the reflector and configured to emit second electromagnetic radiation within a second frequency band, the first frequency band and the second frequency band being different from each other, wherein the second radiating element extends forwardly from the reflector further than the first radiating element; and a compensation structure mounted on the second radiating element and in front of the first radiating element, configured to partially reflect received first electromagnetic radiation backwards, so as to at least partially compensate for coupling interference of the second radiating element to the first radiating element.

According to a third aspect of the present disclosure, a multiband antenna is provided, comprising: a reflector; an array of first radiating elements mounted to the reflector configured to emit first electromagnetic radiation within a first frequency band; an array of second radiating elements mounted to the reflector configured to emit second electromagnetic radiation within a second frequency band, the first frequency band and the second frequency band being different from each other, wherein the second radiating element extends forwardly from the reflector further than the first radiating element; and a compensation structure array mounted forwardly of at least a portion of the first radiating elements of the array of first radiating elements, and configured to partially reflect received first electromagnetic radiation backwards.

### BRIEF DESCRIPTION OF THE DRAWINGS

The present disclosure will be explained in more detail by means of embodiments with reference to the accompanying drawings. The schematic drawings are briefly described as follows:

FIG. 1 is a schematic end view of a multiband antenna according to some examples of the present disclosure.

FIG. 2 is an exemplary perspective view of the multiband antenna of FIG. 1 with a radome removed.

FIG. 3 is an exemplary front view of the multiband antenna of FIG. 2.

FIGS. 4A-4E illustrate some exemplary arrangements of a compensation structure within a multiband antenna.

FIG. 5 is a partial view of the multiband antenna of FIG. 2, showing an exemplary installation manner of the compensation structure.

FIG. 6 is an exemplary design solution for a compensation plate of the compensation structure of the multiband antenna of FIG. 2.

FIGS. 7 and 8 are exemplary design solutions of a multiband antenna with a compensation structure having a narrow operating bandwidth according to some examples of the present disclosure, respectively.

FIGS. 9A-9D are some exemplary front views of a multiband antenna according to some examples of the present disclosure, showing different arrangements of a compensation structure array.

### DETAILED DESCRIPTION

The present disclosure will be described below with reference to the attached drawings, which show several examples of the present disclosure. However, it should be understood that the present disclosure can be presented in many different ways and is not limited to the examples described below. In fact, the examples described below are intended to make the present disclosure more complete and to fully explain the protection scope of the present disclosure to those skilled in the art. It should also be understood that the examples disclosed in the present disclosure may be combined in various ways so as to provide more additional embodiments.

It should be understood that the terms used herein are only used to describe specific examples, and are not intended to limit the scope of the present disclosure. All terms used herein (including technical terms and scientific terms) have meanings normally understood by those skilled in the art unless otherwise defined. For brevity and/or clarity, well-known functions or structures may not be further described in detail.

As used herein, spatial relationship terms such as “upper”, “lower”, “left”, “right”, “front”, “back”, “high”, and “low” can explain the relationship between one feature and another in the attached drawings. It should be understood that, in addition to the orientations shown in the attached drawings, the terms expressing spatial relations also comprise different orientations of a device in use or operation. For example, when a device in the attached drawings rotates reversely, the features originally described as being “below” other features now can be described as being “above” the other features. The device may also be oriented by other means (rotated by 90 degrees or at other locations), and at this time, a relative spatial relation will be explained accordingly.

As used herein, the term “A or B” comprises “A and B” and “A or B”, not exclusively “A” or “B”, unless otherwise specified.

As used herein, the term “schematic” or “exemplary” means “serving as an example, instance or explanation”, not as a “model” to be accurately copied. Any realization method described exemplarily herein may not be necessarily interpreted as being preferable or advantageous over other realization methods. Furthermore, the present disclosure is not limited by any expressed or implied theory given in the above technical field, background art, summary of the invention or specific embodiments.

As used herein, the word “basically” means including any minor changes caused by design or manufacturing defects, device or component tolerances, environmental influences, and/or other factors.

As used herein, the term “partially” may be a part of any proportion. For example, it may be less than 1%, 5%, 10%, 20%, 30%, 40%, 50%, 60%, 70%, 80%, or 90%.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

The present disclosure relates to a base station antenna, which may include a reflector, an array of radiating elements, and a compensation structure or compensation structure array for the array of radiating elements, and the compensation structure array may include a plurality of spaced compensation structures mounted in front of corresponding radiating elements. The compensation structure (array) may be a partially reflective structure and configured to partially reflect received or incident first electromagnetic radiation emitted by the radiating element array backwards. The “partially reflect” may be understood as reflecting a first portion (or a first portion of energy) of the received first electromagnetic radiation backwards, while allowing a second portion to pass to continue to travel forward, where the first portion may account for at most, e.g., 60%, 50%, 40%, 30%, 20%, 10%, 5%, 2%, or 1% of the total energy of the received first electromagnetic radiation.

After the first portion of the received first electromagnetic radiation is reflected backwards by the compensation structure, the first electromagnetic radiation of the first portion can travel backwards to reach the reflector and be reflected forward by the reflector, thereby reaching the compensation structure again and being partially reflected backwards by the compensation structure again. As such, each compensation structure may be positioned to form a Fabry-Pérot resonant cavity with the reflector for the first electromagnetic radiation. Based on the Fabry-Pérot resonant cavity, the first electromagnetic radiation emitted by the array of radiating elements may be gathered (or collected) in its maximum radiation direction, so that a beam formed by the first electromagnetic radiation is narrowed.

In some examples of the present disclosure, the array of radiating elements may obtain a desired narrowed beam width with the formation of an I-type antenna array rather than an L-type antenna array. The I-type antenna array may be understood to include a vertically extending column of radiating elements without any horizontally offset additional radiating elements from the vertically extending column of radiating elements. As such, the above mentioned deficiencies of the L-type antenna array-based solution are at least partially avoided.

In some examples of the present disclosure, a base station antenna configured as a multiband antenna is provided, and the multiband antenna may include: a reflector; a first radiating element configured to emit first electromagnetic radiation within a first frequency band; a second radiating element configured to emit second electromagnetic radiation within a second frequency band, the first frequency band and the second frequency band being different from each other. The second radiating element may extend forwardly from the reflector further than the first radiating element; and the multiband antenna may include a compensation structure mounted on the second radiating element and in front of the first radiating element. The compensation structure may be configured to partially reflect received first electromagnetic radiation backwards so as to at least partially compensate for coupling interference of the second radiating element to the first radiating element.

In the multiband antenna, undesirable inter-band or intra-band coupling interference may occur between different arrays. In some cases, a low-band radiating element may produce undesirable scattering interference to a mid-band radiating element behind it or below it. In some cases, undesirable coupling interference may also occur between adjacent two arrays of mid-band radiating elements. The interference can cause distortion of a radiation pattern of the array of radiating elements, which may include but not limited to: decreased antenna gain, worse roll-off characteristics of the radiation pattern, and/or increased beam width. The multiband antenna of the present disclosure can at least partially reduce distortion of the radiation pattern caused by coupling interference by means of the compensation structure.

Examples of the present disclosure are now described in more detail with reference to the attached drawings.

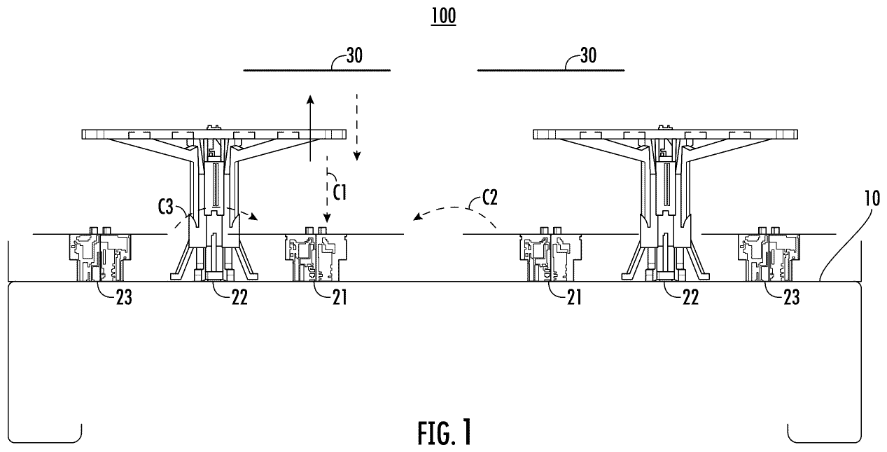

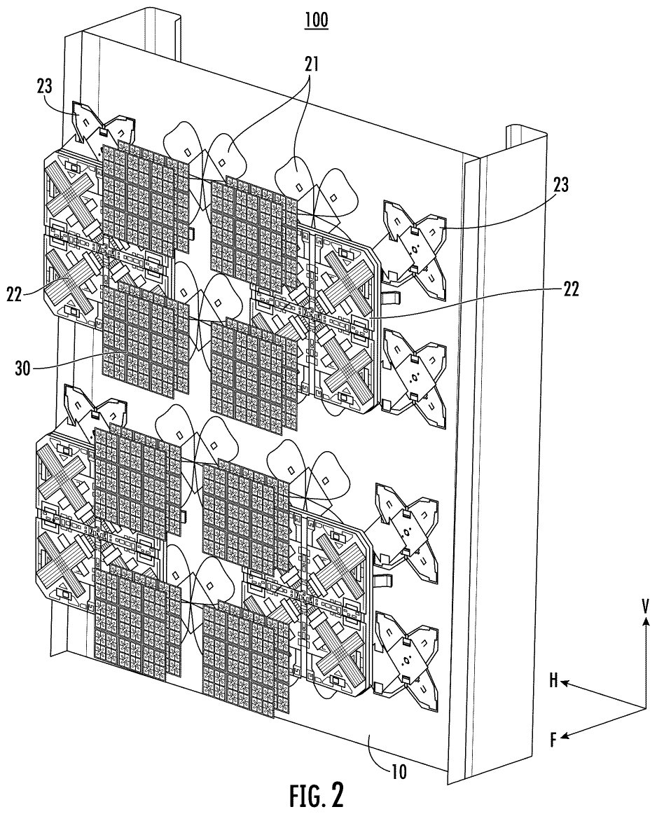

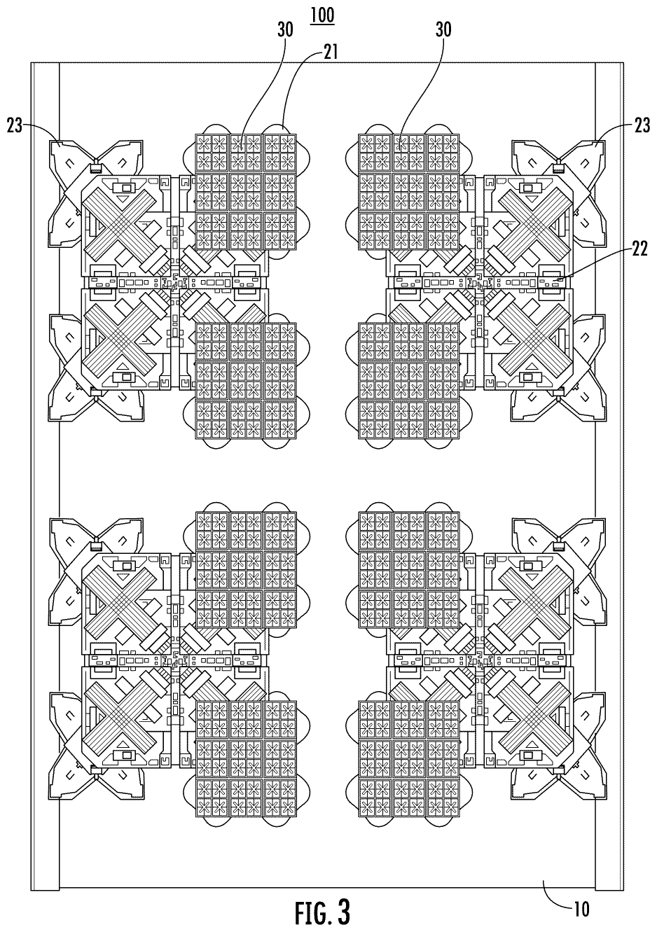

Referring to FIGS. 1-3, schematic end views, exemplary perspective views, and exemplary front views of a multiband antenna 100 according to some examples of the present disclosure are shown, respectively.

As shown in FIGS. 1-3, the multiband antenna 100 may include an array of first radiating elements 21, an array of second radiating elements 22, and (optional) an array of third radiating elements 23 configured as linear arrays, respectively. It should be noted that the actual antenna may also have other components, and in order to avoid obscuring the main points of the present disclosure, the other components are not shown in the accompanying drawings and will not be discussed herein.

Each array of first radiating elements 21 may include a plurality of first radiating elements 21 arranged in a longitudinal direction V, and configured to operate in a first frequency band. Each array of second radiating elements 22 may include a plurality of second radiating elements 22 arranged in the longitudinal direction V, and configured to operate in a second frequency band. Each array of third radiating elements 23 may include a plurality of third radiating elements 23 arranged in the longitudinal direction V, and configured to operate in a third frequency band. The longitudinal direction V may be the direction of a longitudinal axis of the multiband antenna 100 or may be parallel to the longitudinal axis. The longitudinal direction V is perpendicular to a horizontal direction H and a forward direction F. Each radiating element is mounted to extend forwardly (along a forward direction F) from the reflector 10. The reflector 10 may serve as a ground plane structure of each radiating element.

As shown in FIG. 1, the second radiating element 22 may extend forwardly from the reflector 10 further than the first radiating element 21 and the third radiating element 23. In some examples, the first radiating element 21 may, for example, be a mid-band radiating element whose frequency band may be at least a portion of the 1427-2690 MHz frequency band. The second radiating element 22 may be, for example, a low-band radiating element whose frequency band may be at least a portion of the 617-960 MHz frequency band. The third radiating element 23 may, for example, be a mid-band radiating element whose frequency band may be at least a portion of the 1695-2690 MHz or 1427-2690 MHz frequency band. It should be understood that the first radiating element 21 and/or the second radiating element 22 and/or the third radiating element 23 may also be configured as a radiating element that can operate in other frequency bands. This is not limited in the current examples. Additionally or alternatively, the multiband antenna 100 may further include a high-band radiating element (not shown), whose frequency band may be at least a portion of the 3500-5000 MHz frequency band.

In order to achieve a compact structure, the second radiating element 22 may at least partially cover the first radiating element 21 and the third radiating element 23, such that an axis perpendicular to the reflector 10 can intersect the first radiating element 21 and the second radiating element 22 and another axis perpendicular to the reflector 10 can intersect the second radiating element 22 and the third radiating element 23. That is, the first radiating element 21 and the second radiating element 22 may at least partially overlap in the forward direction F, and the second radiating element 22 and the third radiating element 23 may at least partially overlap in the forward direction F.

However, such a compact structure may result in undesirable scattering interference. That is, the second radiating element 22 may have a large scattering effect on the first radiating element 21 (and possibly the third radiating element 23) in the rear area. Such scattering interference may undesirably cause distortion of the radiation pattern of the first array of radiating elements 21, such as an increase in the beam width. In FIG. 1, such scattering interference is represented by C1.

Coupling interference may also occur between adjacent arrays of first radiating elements 21, and such coupling interference may undesirably cause distortion of the radiation pattern of the array of first radiating elements 21. In FIG. 1, such coupling interference is represented by C2.

Coupling interference may also occur between adjacent arrays of first radiating elements 21 and third radiating elements 23, and such coupling interference may undesirably cause distortion of the radiation pattern of the array of first radiating elements 21. In FIG. 1, such coupling interference is represented by C3.

With continued reference to FIGS. 1-3, the multiband antenna 100 may include a compensation structure 30 for the first radiating element 21 or an array of compensation structures 30 for at least a portion of the array of first radiating elements 21. The compensation structure 30 (array) may be configured to at least partially compensate for the coupling interference, that is, at least partially reduce the distortion caused by the coupling interference to the radiation pattern of the array of first radiating elements 21.

Advantageously, each compensation structure 30 may be positioned to form a Fabry-Pérot resonant cavity with the reflector 10 for the first electromagnetic radiation. Based on the Fabry-Pérot resonant cavity, the first electromagnetic radiation emitted by the array of first radiating elements 21 may be gathered (or collected) in its maximum radiation direction, so that a beam formed by the first electromagnetic radiation is narrowed.

In order to form a Fabry-Perot resonant cavity for the first electromagnetic radiation, the compensation structure 30 may be substantially parallel to the reflector 10 and configured to planarly cover the front of the first radiating element 21. The compensation structure 30 may at least partially cover the corresponding first radiating element 21, such that the axis perpendicular to the reflector 10 intersects the compensation structure 30 and the first radiating element 21, that is, the first radiating element 21 and the compensation structure 30 at least partially overlap in the forward direction F.

In order to achieve flexible commissioning possibilities, a compact compensation structure 30 is desired. In the views of FIGS. 1-3, one compensation structure 30 may be configured to at least partially cover one first radiating element 21. That is, the dimension of one compensation structure 30 may substantially correspond to the dimension of one first radiating element 21, thereby achieving a compact compensation structure 30. The compact compensation structure 30 may be improved in one or more of the following aspects as compared to a dielectric lens-based solution: antenna size, manufacturing cost, antenna weight, and/or commissioning difficulty.

In some examples, each compensation structure 30 has a first projection surface on the reflector 10, each first radiating element 21 has a second projection surface on the reflector 10, and an overlap surface between the first projection surface and the second projection surface accounts for at least e.g., 50%, 60%, 70%, 80%, or 90% of the second projection surface.

In some examples, the horizontal dimension of the first projection surface may be between 80% and 100% of the horizontal dimension of the second projection surface, and the vertical dimension of the first projection surface may be between 80% and 100% of the vertical dimension of the second projection surface.

It should be understood that one compensation structure 30 may also be configured to at least partially cover a plurality of first radiating elements 21. In some examples, one compensation structure 30 may be configured to be elongate and at least partially cover two adjacent first radiating elements 21. In some examples, one compensation structure 30 may be positioned between adjacent two first radiating elements 21, and at least partially cover these two first radiating elements 21. In some examples, the first projection surface may be at least 100%, 150%, 200%, 400%, 500%, etc. of the second projection surface. The horizontal dimension of the first projection surface may be between 100% and 200% of the horizontal dimension of the second projection surface. The vertical dimension of the first projection face may be between 100% and 200% of the vertical dimension of the second projection face.

The compensation structure 30 may be configured as a partially reflective structure to partially reflect backwards (shown with dashed arrows in FIG. 1) the incident first electromagnetic radiation (shown with solid arrows in FIG. 1). After the first portion of the received first electromagnetic radiation is reflected backwards by the compensation structure 30, the first electromagnetic radiation of the first portion can travel backwards to reach the reflector 10 and be reflected forward by the reflector 10, thereby reaching the compensation structure 30 again and being partially reflected backwards by the compensation structure 30 again. The various portions of the first electromagnetic radiation may have a superimposed addition effect in their maximum radiation direction, while may have a superimposed reduction effect in the radiation direction on the side. Thus, the first electromagnetic radiation emitted by the array of first radiating elements 21 may be gathered (or collected) in its maximum radiation direction, so that the beam formed by the first electromagnetic radiation is narrowed.

Additionally or alternatively, the various portions of the first electromagnetic radiation that are partially reflected by the compensation structure 30 may be configured to at least partially counteract coupling interference from the surrounding environment (including adjacent arrays of radiating elements) such that cleaner first electromagnetic radiation is approached.

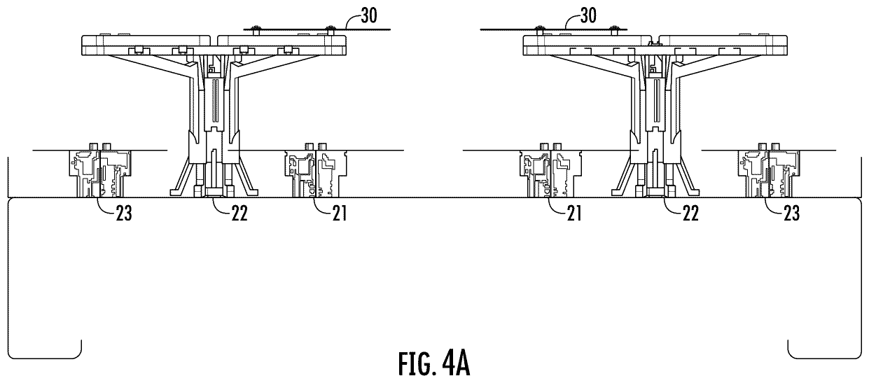

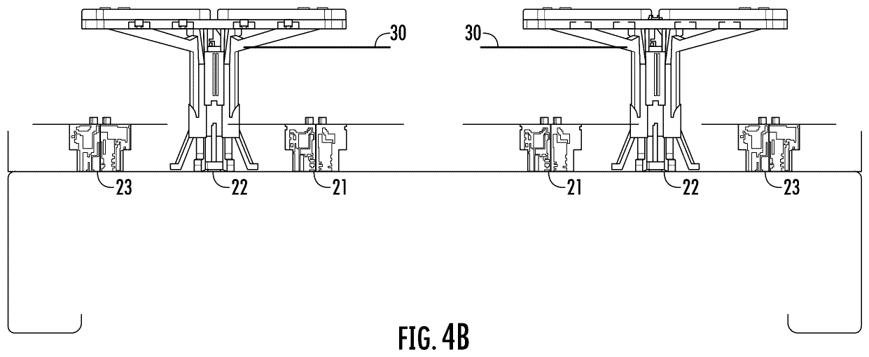

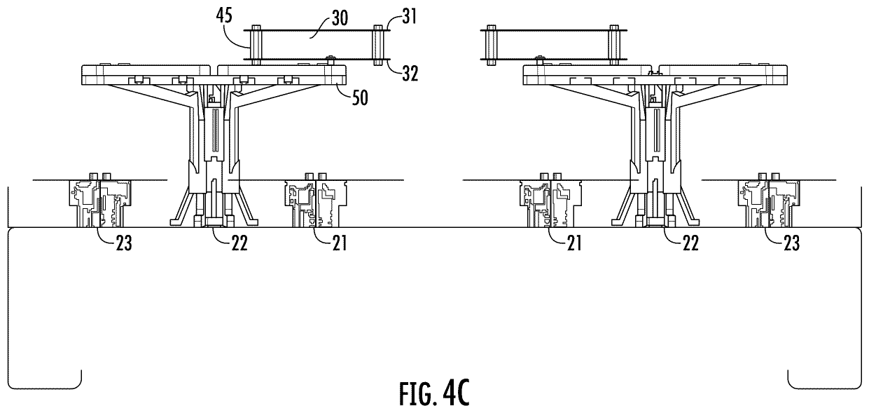

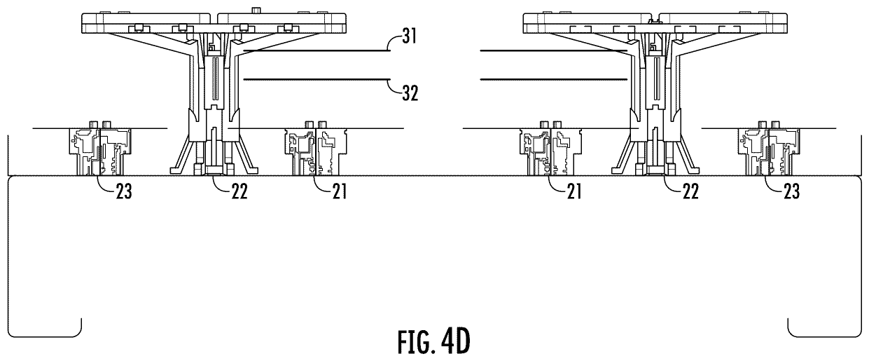

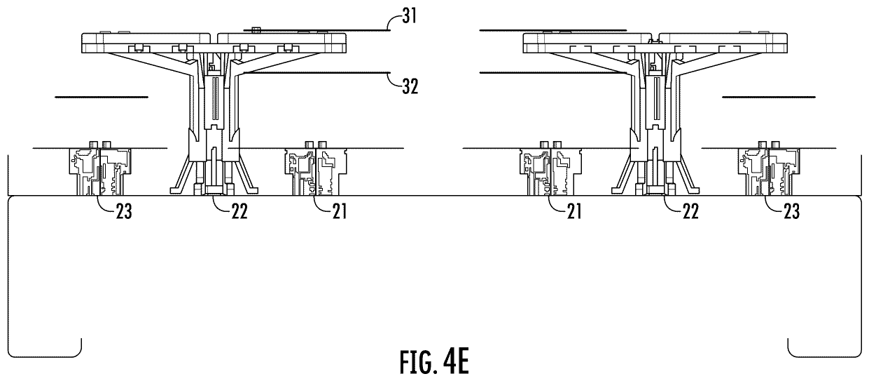

Next, some exemplary arrangements of the compensation structure 30 in the multiband antenna 100 are shown with reference to FIGS. 4A-4E, respectively.

As shown in FIGS. 4A and 4B, the compensation structure 30 may be configured as a single-layer compensation structure. That is, the compensation structure 30 may be configured as a single-layer compensation plate. The compensation plate may be disposed substantially parallel to the reflector 10 in order to form a Fabry-Pérot resonant cavity with the reflector 10 for the first electromagnetic radiation.

As shown in FIGS. 4C-4E, the compensation structure 30 may be configured as a multilayer compensation structure (a two-layer compensation structure 30 is shown in the figures). That is, the compensation structure 30 may include a first compensation plate 31 and a second compensation plate 32 spaced apart from the first compensation plate 31. The first compensation plate 31 may be positioned to form a first Fabry-Pérot resonance cavity with the reflector 10 for the first electromagnetic radiation, and the second compensation plate 32 may be positioned to form a second Fabry-Perot resonance cavity with the reflector 10 for the first electromagnetic radiation.

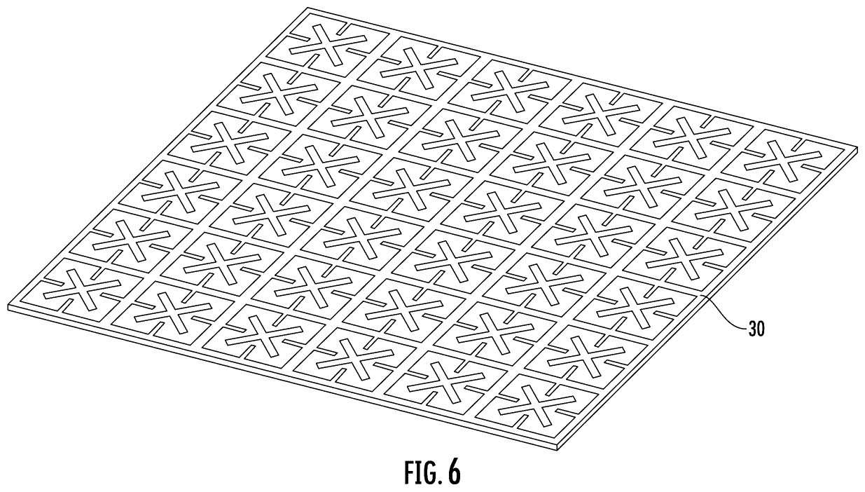

In some examples, the compensation plates 30, 31, 32 may be implemented as printed circuit boards (as shown in FIG. 6). A corresponding metal pattern may be printed on the printed circuit board, forming a frequency selective surface structure. The compensation plate is, by its nature, a spatial filter that interacts with an electromagnetic wave to exhibit, for example, significant low-pass or band-stop filtering characteristics.

In some examples, the compensation plates 30, 31, 32 may be configured as spatial low-pass filters such that the compensation plates allow substantial (e.g., more than 70%, 80%, 90%, 95%, 99%) electromagnetic waves in the second frequency band (i.e., the low frequency band) to pass, while partially reflect electromagnetic waves in the first frequency band (i.e., the middle frequency band).

In some examples, the compensation plates 30, 31, 32 may be configured as spatial band-stop filters such that the compensation plates allow substantial (e.g., more than 70%, 80%, 90%, 95%, 99%) electromagnetic waves in the low frequency band and the high frequency band to pass, while partially reflect electromagnetic waves in the middle frequency band.

A compensation structure 30 with a narrow operating bandwidth is desirable. A narrow operating bandwidth means that the compensation structure 30 may specifically adjust only a radiation pattern within a target sub-band without negatively affecting a radiation pattern outside the target sub-band.

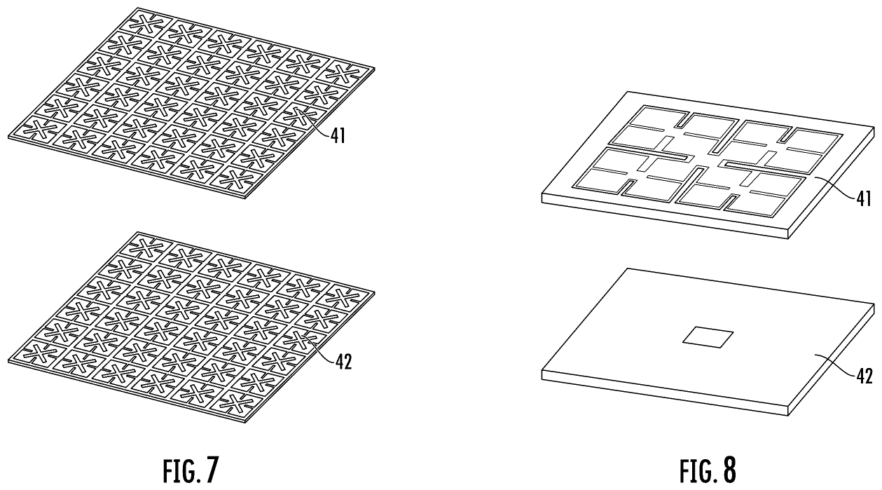

Referring to FIGS. 7 and 8, exemplary design solutions for the compensation structure 30 having a narrow operating bandwidth are shown, respectively.

As shown in FIG. 7, the compensation structure 30 may achieve a narrow operating bandwidth by means of a multi-layer low-pass surface structure. In the case of a single-layer compensation structure, the single-layer compensation plate 30 may include a first metal pattern surface 41 disposed on a first side and a second metal pattern surface 42 disposed on an opposite second side. In the case of a double-layer compensation structure, the first compensation plate 31 may include a first metal pattern surface 41, while the second compensation plate 32 may include a second metal pattern surface 42. In some examples, the first metal pattern surface 41 and the second metal pattern surface 42 may include passive resonant units in periodic arrangement and be configured as low-pass surface structures. The second metal pattern surface 42 and the first metal pattern surface 41 may interact with each other in order to narrow the operating bandwidth of the compensation structure 30.

As shown in FIG. 8, the compensation structure 30 may achieve a narrow operating bandwidth by means of a low-pass surface structure and a band-stop surface structure. In the case of a single-layer compensation structure, the single-layer compensation plate may include a first metal pattern surface 41 disposed on a first side and a second metal pattern surface 42 disposed on an opposite second side. In the case of the double-layer compensation structure 30, the first compensation plate 31 may include a first metal pattern surface 41, while the second compensation plate 32 may include a second metal pattern surface 42. In some examples, the first metal pattern surface 41 may include passive resonant units in periodic arrangement and be configured as a band-stop surface structure. The second metal pattern surface 42 may include a metal block (as shown in FIG. 8) or passive resonant units in periodic arrangement and configured as a low-pass surface structure. The second metal pattern surface 42 and the first metal pattern surface 41 may interact with each other in order to narrow the operating bandwidth of the compensation structure 30.

It should be understood that the metal pattern surface in the illustration is only exemplary. The implementation form of the metal pattern surface is not limited to these examples, but can be extended to any feasible pattern form.

It should be understood that the compensation plates 30, 31, 32 may be implemented as stamped metal plates on which corresponding metal patterns may be formed. It is possible that the corresponding stamped metal plates may be fixed by means of a dielectric substrate.

The thickness of the compensation plates 30, 31, 32 may be very thin (e.g., 1-5 mm), regardless of whether they are printed circuit boards or stamped metal plates. Therefore, the base station antenna according to the examples of the present disclosure can reduce the size (e.g., the thickness) of the base station antenna and improve heat dissipation compared to a conventional base station antenna with spherical lenses, hemispherical lenses, or columnar lenses with circular or semicircular cross sections.

With continued reference to FIGS. 4A-4E, the compensation plates 30, 31, 32 may be positioned at different heights from the reflector 10, and the heights of the compensation plates 30, 31, 32 are closely related to the operating frequency band of the Fabry-Pérot resonant cavity, which is applicable to:

$$Hopt = λ \frac{( φ1 + φ2 )}{4 π} - λ \frac{n}{2} , n = 0 , \pm 1 , \pm 2 …$$

where Hopt represents the distances between the compensation plates 30, 31, 32 and the reflector 10, λ represents the wavelength corresponding to a target frequency point, φ1 represents reflective phases of the compensation plates 30, 31, 32, and φ2 represents a reflective phase of the reflector 10.

Thus, once the target frequency point is determined, the distances from the compensation plate 30, 31, 32 to the reflector 10 may also be set. In some examples, the first compensation plate 31 may be configured to reach a first distance from the reflector 10, and the first distance is associated with a first sub-band within the first frequency band (e.g., 1.427-1.518 G, or 1.695-2.2 G), where the first compensation plate 31 is configured to narrow the beam width of the first electromagnetic radiation within the first sub-band. The second compensation plate 32 may be configured to reach a second distance from the reflector 10, and the second distance is associated with a second sub-band (e.g., 2.3-2.69 G) different from the first sub-band within the first frequency band, where the second compensation plate 32 is configured to narrow the beam width of the first electromagnetic radiation within the second sub-band.

In some examples, because the first compensation plate 31 is designed for the first sub-band, the first compensation plate 31 may negatively affect the radiation pattern within the second sub-band. In some cases, the first compensation plate 31 may cause distortion of the radiation pattern within the second sub-band, such as a drop in gain, an increase in beam width, and/or the like. Therefore, the second compensation plate 32 may be configured to compensate for impact of the first compensation plate 31 on the first electromagnetic radiation within the second sub-band, and thereby narrow the operating bandwidth of the compensation structure 30 on the first electromagnetic radiation, and may limit the operating bandwidth of the compensation structure 30 within the first sub-band. The dual-compensation plate-based design solution allows for more flexibility in debugging the radiation pattern to achieve more desirable radiation pattern characteristics.

It should be understood that the compensation structure 30 may alternatively include more compensation plates. In some examples, the compensation structure 30 may include a third compensation plate (not shown) spaced apart from the first compensation plate 31 and the second compensation plate 32, the third compensation plate being positioned to form a third Fabry-Perot resonance cavity with the reflector 10 for the first electromagnetic radiation.

In order to achieve a reliable and efficient assembly of the compensation structure 30 in a compact space, the compensation structure 30 may be mounted on the second radiating element 22 that is originally in front of the first radiating element 21. Depending on the target frequency point, the corresponding compensation plate may be mounted in front of or behind the second radiating element 22. In the example of FIG. 4A, the single-layer compensation plate is mounted in front of the second radiating element 22. In the example of FIG. 4B, the single layer compensation plate is mounted behind the second radiating element 22. In the example of FIG. 4C, the first compensation plate 31 and the second compensation plate 32 are both mounted in front of the second radiating element 22. In the example of FIG. 4D, the first compensation plate 31 and the second compensation plate 32 are both mounted behind the second radiating element 22. In the example of FIG. 4E, the first compensation plate 31 is mounted in front of the second radiating element 22, and the second compensation plate 32 is mounted behind the second radiating element 22.

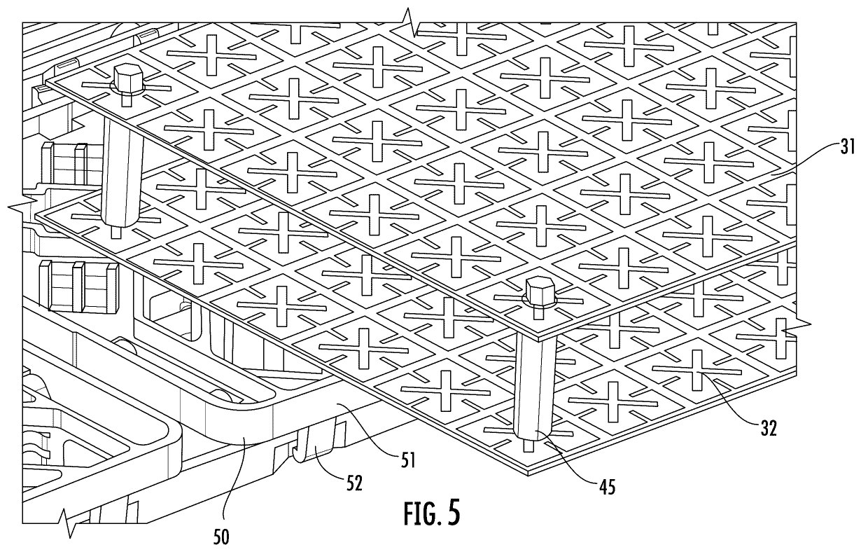

Next, refer to FIG. 4C and FIG. 5 for an assembly method for the compensation plate on the second radiating element 22. The compensation structure 30 may include at least one support post 45 for mounting the compensation plate to the second radiating element 22. Advantageously, the compensation structure 30 may include four support posts 45 disposed on four corners of the compensation structure 30, thereby enabling robust mounting of the compensation structure 30.

As shown in FIGS. 4C and 5, the second radiating element 22 may include a dipole arm and a dipole arm support structure 50. The dipole arm support structure 50 may be made of a dielectric material, for example, configured as a plastic support structure. A joint portion, such as a support buckle, may be provided on the dipole arm support structure 50, and a support end of the support post 45 may be engaged, such as inserted into the joint portion.

In some examples, the dipole arm support structure 50 may include a cover plate 51 and a support plate 52. A first support buckle (not specifically shown) for engaging the compensation structure 30, such as the first compensation plate 31, is provided on the cover plate 51, and a second support buckle (not specifically shown) for engaging the compensation structure 30, such as the second compensation plate 32, is provided on the support plate 52.

By means of a close fit between the support post 45 of the compensation structure 30 and the joint portion of the dipole arm support structure 50, a flexible, efficient and reliable assembly of the compensation plate on the second radiating element 22 can be realized.

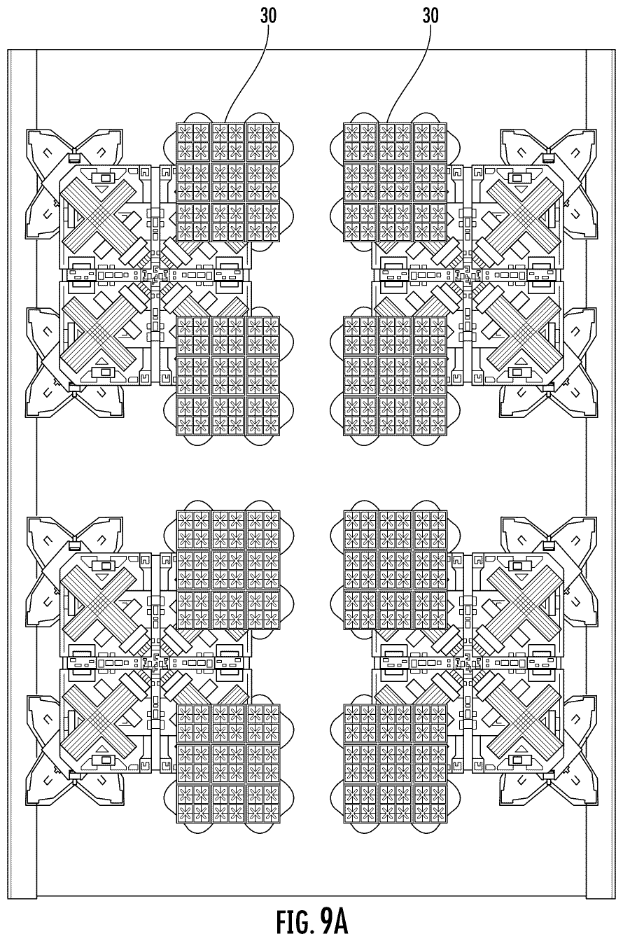

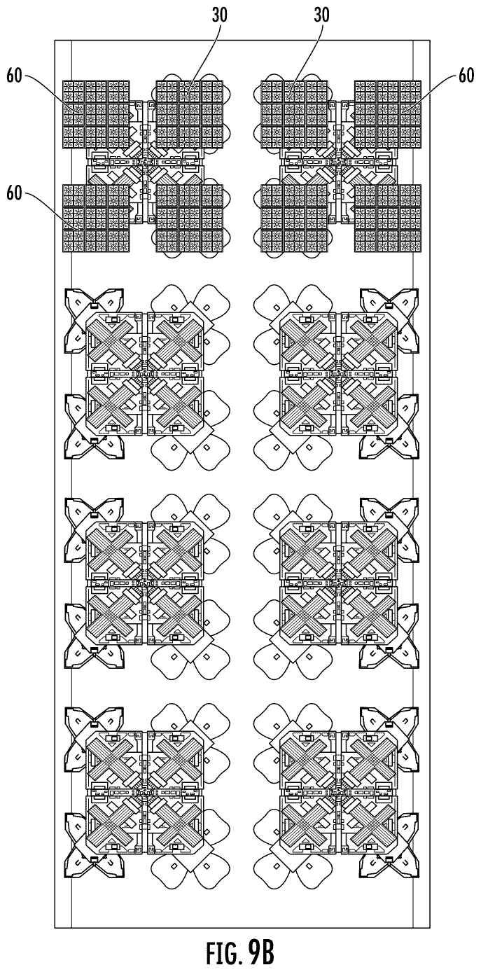

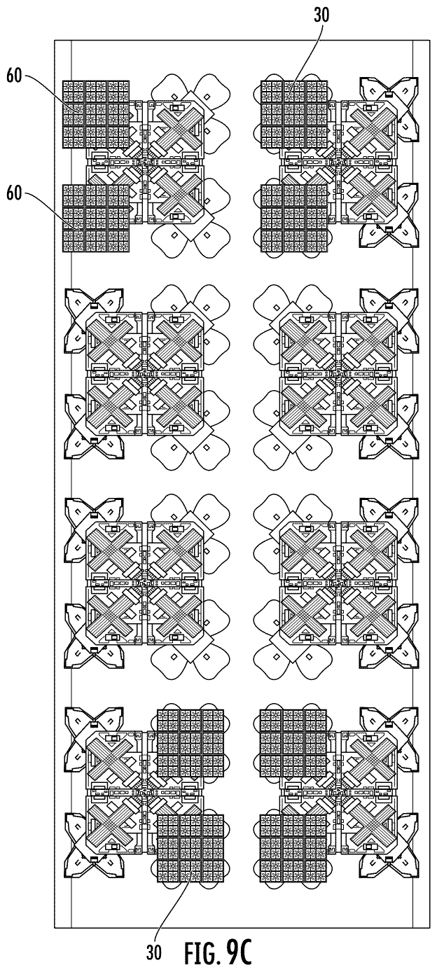

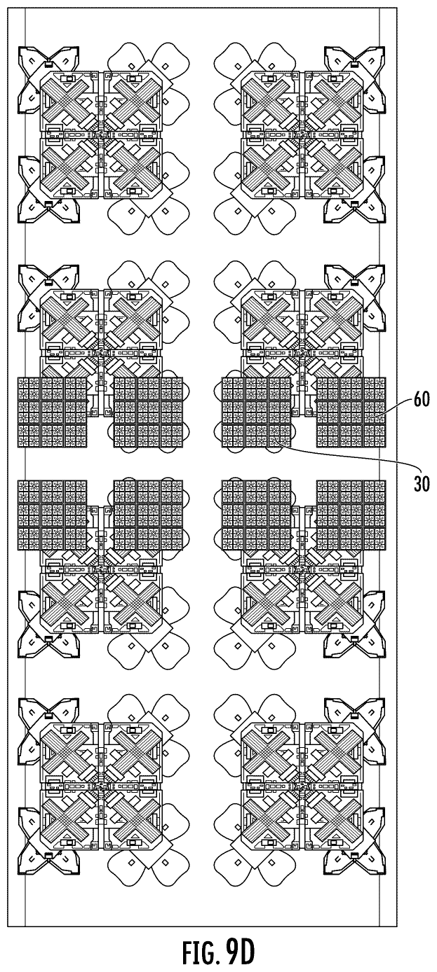

Next, with reference to FIGS. 9A-9D, some exemplary arrangements of the compensation structure array 30 in the multiband antenna 100 are described.

Based on the design form of the compensation structure 30 of the present disclosure, the compensation structure 30 may be flexibly deployed at locations where commissioning is required, and interference with other structures is advantageously avoided.

In some examples, the array of compensation structures 30 may be configured to planarly cover the front of all first radiating elements 21 of the array of first radiating element 21. As shown in FIG. 9A, each first radiating element 21 is covered with the compensation structure 30 in front.

In some examples, the array of compensation structures 30 may be configured to planarly cover the front of a portion of the first radiating elements 21 of the array of first radiating elements 21. As shown in FIGS. 9B, 9C and 9D, only a portion of the first radiating elements 21 is covered with the compensation structure 30 in front. In the examples of FIGS. 9B and 9C, this portion of the first radiating elements 21 may be in the end area of the array of first radiating elements 21. In the example of FIG. 9D, this portion of the first radiating elements 21 may be in the middle region of the array of first radiating elements 21.

In some examples, the multiband antenna 100 may include an additional compensation structure 60. As shown in FIGS. 9B, 9C and 9D, the additional compensation structure 60 is mounted to cover the front of the corresponding third radiating element 23. That is, the multiband antenna 100 may include an array of additional compensation structures 60 that may be configured to planarly cover the front of at least a portion of the third radiating elements 23 of the array of third radiating elements 23. The design form, assembly manner, and its function of the additional compensation structure 60 may be similar to those of the compensation structure 30, which is not repeated here. In some examples, the additional compensation structure 60 may alternatively be configured as an integral compensation structure (not shown in the figures) with the compensation structure 30. In some examples, an integral compensation structure may be configured to be elongate and at least partially cover adjacent first and third radiating elements 21 and 23.

Although exemplary examples of the present disclosure have been described, those skilled in the art should understand that many variations and modifications are possible in the exemplary examples without materially departing from the spirit and scope of the present disclosure. Therefore, all variations and changes are included in the protection scope of the present disclosure defined by the claims. The present disclosure is defined by the attached claims, and equivalents of these claims are also included. 1

1. A base station antenna, comprising:
a reflector;
an array of first radiating elements mounted forwardly of the reflector and configured to emit first electromagnetic radiation within a first frequency band; and
a compensation structure mounted forwardly of at least a portion of the first radiating elements of the array of first radiating elements and configured to reflect at least some received first electromagnetic radiation backwards, wherein the compensation structure comprises a first compensation plate and a second compensation plate spaced apart from the first compensation plate, the first compensation plate being positioned to form a first Fabry-Pérot resonance cavity with the reflector for the first electromagnetic radiation, and the second compensation plate being positioned to form a second Fabry-Pérot resonance cavity with the reflector for the first electromagnetic radiation.

2. (canceled)

3. The base station antenna according to claim 1, wherein the first compensation plate and the second compensation plate are respectively arranged substantially parallel to the reflector.

4.-5. (canceled)

6. The base station antenna according to claim 1, wherein the compensation structure is configured to substantially not reflect second electromagnetic radiation outside the first frequency band, and allow the second electromagnetic radiation to pass through.

7. The base station antenna according to claim 1, wherein only a portion of the first radiating elements is covered with the compensation structure in front.

8.-12. (canceled)

13. The base station antenna according to claim 1, wherein the first compensation plate and the second compensation plate are respectively configured as spatial low-pass filters or spatial band-stop filters.

14.-15. (canceled)

16. The base station antenna according to claim 1, wherein the first compensation plate comprises a first metal pattern surface provided on a first side, and the first metal pattern surface comprises passive resonance units arranged periodically, and is configured as a low-pass surface structure or a band-stop surface structure.

17.-19. (canceled)

20. The base station antenna according to claim 1, wherein the base station antenna further comprises an array of second radiating elements configured to transmit second electromagnetic radiation within a second frequency band, wherein each second radiating element extends forwardly from the reflector further than each first radiating element, and the compensation structure is mounted on the corresponding second radiating element.

21. The base station antenna according to claim 20, wherein the first compensation plate is mounted in front of the second radiating element and the second compensation plate is mounted behind the second radiating element.

22. (canceled)

23. The base station antenna according to claim 20, wherein the compensation structure includes at least one support post, and the first compensation plate and the second compensation plate are respectively fixed on the at least one support post by a spaced apart distance.

24.-25. (canceled)

26. The base station antenna according to claim 1, wherein the compensation structure comprises a third compensation plate spaced apart from the first compensation plate and the second compensation plate, and the third compensation plate is positioned to form a third Fabry-Perot resonance cavity with the reflector for the first electromagnetic radiation.

27. A multiband antenna, comprising:
a reflector;
a first radiating element mounted to the reflector and configured to emit first electromagnetic radiation within a first frequency band;
a second radiating element mounted to the reflector and configured to emit second electromagnetic radiation within a second frequency band, the first frequency band and the second frequency band being different from each other, wherein the second radiating element extends forwardly from the reflector further than the first radiating element; and
a compensation structure mounted on the second radiating element and in front of the first radiating element, configured to partially reflect received first electromagnetic radiation backwards, so as to at least partially compensate for coupling interference of the second radiating element to the first radiating element.

28. The multiband antenna according to claim 27, wherein the compensation structure is configured to planarly cover the front of the first radiating element.

29.-31. (canceled)

32. The multiband antenna according to claim 27, wherein the compensation structure comprises a first compensation plate positioned to form a first Fabry-Pérot resonance cavity with the reflector for the first electromagnetic radiation.

33. The multiband antenna according to claim 32, wherein the compensation structure comprises a second compensation plate positioned to form a second Fabry-Pérot resonance cavity with the reflector for the first electromagnetic radiation.

34. (canceled)

35. The multiband antenna according to claim 33, wherein the first compensation plate is configured to reach a first distance from the reflector, and the first distance is associated with a first sub-band within the first frequency band, wherein the first compensation plate is configured to narrow a beam width of the first electromagnetic radiation within the first sub-band.

36. The multiband antenna according to claim 35, wherein the second compensation plate is configured to reach a second distance from the reflector, and the second distance is associated with a second sub-band different from the first sub-band within the first frequency band, wherein the second compensation plate is configured to:
narrow a beam width of the first electromagnetic radiation within the second sub-band; and/or
compensate for impact of the first compensation plate on the first electromagnetic radiation within the second sub-band, and thereby narrow an operating bandwidth of the compensation structure on the first electromagnetic radiation.

37.-44. (canceled)

45. A multiband antenna, comprising:
a reflector;
an array of first radiating elements mounted to the reflector configured to emit first electromagnetic radiation within a first frequency band;
an array of second radiating elements mounted to the reflector configured to emit second electromagnetic radiation within a second frequency band, the first frequency band and the second frequency band being different from each other, wherein the second radiating element extends forwardly from the reflector further than the first radiating element; and
a compensation structure array mounted forwardly of at least a portion of the first radiating elements of the array of first radiating elements, and configured to partially reflect received first electromagnetic radiation backwards.

46. The multiband antenna according to claim 45, wherein the array of first radiating elements is configured as an I-type array.

47. The multiband antenna according to claim 46, wherein the compensation structure array is configured to narrow a beam width of the first electromagnetic radiation within the first frequency band.

48.-49. (canceled)

50. The multiband antenna according to claim 45, wherein the compensation structure array comprises a first compensation plate array and a second compensation plate array, the first compensation plate array is positioned to form a first Fabry-Pérot resonant cavity array with the reflector for the first electromagnetic radiation, and the second compensation plate array is positioned to form a second Fabry-Pérot resonant cavity array with the reflector for the first electromagnetic radiation.
